(19) United States
(12) Patent Application Publication
(10) Pub. No.: US 2010/0199262 A1
(43) Pub. Date: Aug. 5, 2010

(54) System For Identifying Attributes And Events With Immutable Sequential Numbers

(76) Inventor: Wynne Crisman, Colorado Springs, CO (US)

Correspondence Address: DECLARATIVE ENGINEERING, LLC, 232 CUSTAR AVE., COLORADO SPRINGS, CO, 80903, US

(21) Appl. No.: 12/366,387

(22) Filed: Feb. 5, 2009

(51) Int. Cl. G06F 9/44

(52) U.S. Cl. 717/108

(57) ABSTRACT

A method of defining attributes and events in an object oriented software system. The attributes and events are defined by the class as hierarchically unique number fields. They are initialized by a call to a metadata storage object which may be passed attribute or event related metadata for subsequent access by the software system.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The present invention is generally related to how attributes are defined in object oriented software systems, and more particularly to how sequential and hierarchically unique numbers are assigned to identifiers as a defining class is loaded by the system, and how those numbers are used to access attribute meta-data and values.

Attributes are an integral part of object oriented programming. All object oriented languages provide basic facilities for attributes and some even provide for the ability to associated meta-data with attributes. However none of the existing languages provide facilities for extended data to be associated with an attribute, value change tracking, or have cross language consistency. Another method commonly used to define enhanced attributes is to place the values in a hash map indexed by the attribute name. This leads to inefficient mapping lookups, provides a very loose structure which leads to unexpected runtime behavior, is more difficult to use by the programmer than traditional attributes, and it doesn't look anything like traditional attribute systems.

### BRIEF SUMMARY OF THE INVENTION

In accordance with the present invention, late binding attributes are defined as class scoped fields which are used to initialize the attribute data structures at runtime. The class scoped fields are assigned unique numbers within the context of the class hierarchy and attribute values are assigned and accessed at runtime via an array allocated per class instance. The class scoped fields also may pass meta-data such as relationships to other attributes, attribute name, defining class, and properties of the attribute which affect its storage and access.

The present invention provides an attribute declaration method that is strongly typed, similar to a native language attribute system, as each attribute is defined on one line and an identifier is used throughout the rest of the code to access an instance's attribute value. It solves many of the problems presented by traditional attribute systems by allowing meta-data to be associated with the attribute definition. The meta-data opens the door for attribute values to be stored differently depending on their structure, attribute values to be incorporated into the defining instance to behave in the system as one unit, attribute changes may trigger automated change events, and many more useful features.

### BRIEF DESCRIPTION OF THE DRAWING

FIG. 1 shows a pseudo code example of a class declaring an attribute.

FIG. 2 details how an attribute declaration could be used to get and set the attribute value.

FIG. 3 shows a pseudo code example of a class declaring an event.

FIG. 4 details how an event declaration could be used to fire events and register to be notified when an event fires.

FIG. 5 depicts an object's structure in memory.

FIG. 6 is a high level diagram showing the relationship between a class and the metadata service.

FIG. 7 is a sequence digram depicting the order of calls when the first instance of a class is generated and used.

### DETAILED DESCRIPTION OF THE INVENTION

The present invention requires that the software language it is implemented in not support multiple class inheritance since sequential attribute and event numbering is predicated on a single chain of inheritance. Multiple inheritance of class interfaces which may not define attributes, but may define events is supported. The invention also requires that the language load the classes in the base class first ordering, such that the inherited classes' attributes and events will load before any of the inheriting classes' attributes and events.

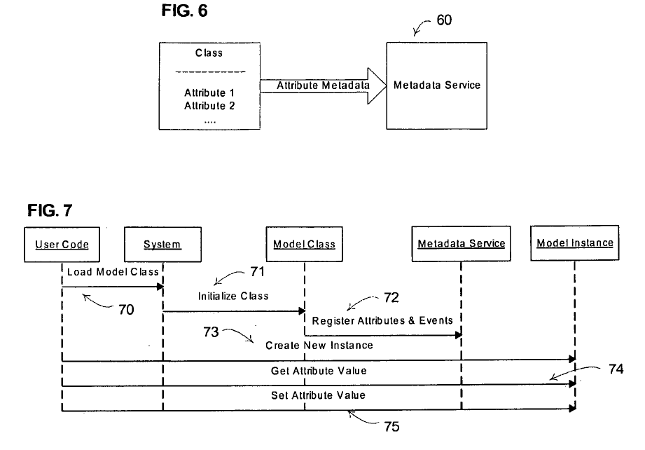

Attributes are defined, as shown in FIG. 1, by developers by calling a registration method 11 which is run when the class is loaded. The register attribute method may be defined either within the class hierarchy, or externally, but must eventually get to the metadata service shown in FIG. 6 60. The metadata service has a block of allocatable attribute numbers and knows the last attribute declared for the class hierarchy. The metadata service will then allocate the next available number, update the last attribute declared field, record the attribute metadata, and return the attribute's number. The attribute registration method returns a sequential number unique within the class hierarchy which is stored 10 in an immutable identifier. Note that the 11 register attribute method must take at the very least a 12 reference to the declaring class, and may pass a 13 textual representation for the attribute, along with 14 other properties of the attribute.

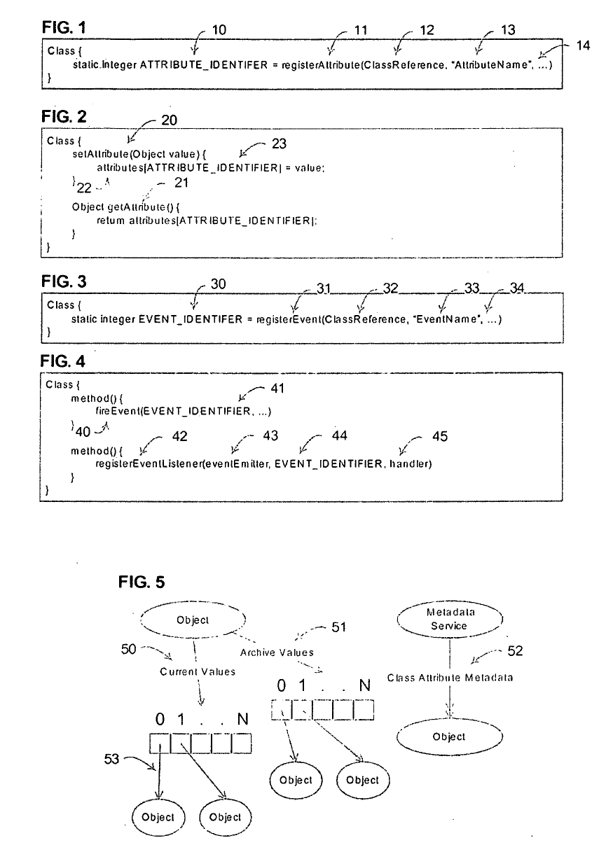

FIG. 2 shows how the declared attribute could be used to 20 set and 21 get an attribute value from an 22 array of attribute values. The 22 array is just long enough to hold all the values for all the class hierarchy's declared attributes. The array can then be 23 indexed by the attribute identifier at runtime to either get or set the attribute's value. This same scenario may be used to store additional data for an attribute, such as an original value, or whether the attribute has been altered. The code to manage the attribute values may also be offloaded into an attribute support class which each model instance references one of. An attribute support class allows the developer the flexibility to reuse the attribute code without requiring inheritance from a single base model class.

Events can also be declared, as demonstrated in FIG. 3, in the same way attributes are declared. An event identifier 30 is defined to hold the hierarchically unique number. The number is generated by a call 31 to a register event method when the class is loaded. The register event method may be defined either within the class hierarchy, or externally, but must eventually get to the metadata service shown in FIG. 6 60. The metadata service has a block of allocatable event numbers and knows the last event declared for the class hierarchy. The metadata service will then allocate the next available number, update the last event declared field, record the event metadata, and return the event's number.

FIG. 4 demonstrates how a previously declared event may be used by an instance of the class. The class instance can fire an event 40 to notify all listeners, passing the 41 event identifier for the event being fired. An event can be 42 listened to by registering an 45 event handler with the event 44 declared by an 43 event emitter.

Events may be declared by interfaces which are classes without the ability to declare attributes or define instance methods. If interfaces are supported by the language, then the event service must define a block of numbers used exclusively by the interface declared events. Since interfaces are generally implementable by many classes and a class may generally implement zero or more interfaces, the event numbers must be globally unique. Each call to register an event from an interface class requires the metadata service to allocate the next number in the global event number pool, record the event metadata, and return the event number.

The object diagram in FIG. 5 depicts an in memory representation of a class instance, or object, that has declared attributes. The object in this scenario references 50 an array of current attribute values and 51 archive attribute values. The attributes have generated attribute metadata 52 which is stored in the metadata service, indexed by the object's class. The attribute arrays reference 53 the attribute's values which can be retrieved or assigned as required by the application.

The sequence diagram shown in FIG. 7, depicts some user code creating and using the first instance of a class. The user code 70 calls the system or class loader to load the model's class. The system then 71 loads the class and initializes it if it hasn't already done so. The class loading must first load any unloaded inherited classes or interfaces. The class is initialized after loading which runs any static or class level code blocks such as the 72 register attribute and register event calls. Once the class has been loaded, the user code can 73 create a new instance of the class. The creation of the new instance allocates space for the object and initializes an array for the attribute values. The user code can now 74 get and 75 set the the attribute values for the model instance.

What is claimed is:

1. A method for defining attributes in an object oriented computer language on a computer readable medium and adapted to operate on a computer as part of defining a class, usable as events, identifying them with hierarchically unique sequential numbers, storing attribute metadata in a metadata service for subsequent access, and providing for an array or arrays to be generated for each class instance for storing the attribute values and related instance level attribute data, comprising of the steps of:
creating a class level identifier field that is immutable; and
assigning the identifier the result of a call to a metadata service to allocate a number for the attribute and to archive the attribute's class level metadata.

2. A method for defining events in an object oriented computer language on a computer readable medium and adapted to operate on a computer as part of defining a class or interface, identifying them with hierarchically unique numbers, storing the event metadata in a metadata service for subsequent access, and providing for each class instance to use the identifier to fire events and register to receive event notifications, comprising the steps of:
creating a class level identifier field that is immutable; and
assigning the identifier the result of a call to a metadata service to allocate a number for the event and to archive the event's class level metadata.
